(19) United States
(12) Patent Application Publication
(10) Pub. No.: US 2014/0032295 A1
(43) Pub. Date: Jan. 30, 2014

(54) METHOD FOR FACILITATING THE ELECTRONIC PURCHASE OF GOODS OR SERVICES

(71) Applicant: Edward Cantrell, Grosse Pointe Woods, MI (US)

(72) Inventor: Edward Cantrell, Grosse Pointe Woods, MI (US)

(21) Appl. No.: 13/950,121

(22) Filed: Jul. 24, 2013

Related U.S. Application Data
(60) Provisional application No. 61/675,243, filed on Jul. 24, 2012.

(51) Int. Cl. G06Q 30/02

(52) U.S. Cl. CPC G06Q 30/0252
USPC 705/14.23

(57) ABSTRACT

Disclosed is a method for facilitating the electronic purchase of any product or a service. Specifically, the method provides a geolocated store for the electronic purchase of products and services that uses a merchant specified geofence to define the electronic offers that are promoted, performed, or otherwise presented to a viewer during an event, and in one embodiment at or near the moment the product or service is promoted, performed, or otherwise presented to the viewer.

### CROSS-REFERENCE TO RELATED APPLICATIONS

This application claims priority to U.S. Provisional Patent Application Ser. No. 61/675,243, filed Jul. 24, 2012, the entire contents of which are incorporated herein by reference

### BACKGROUND OF THE INVENTION

1. Field of the Invention

Disclosed is a method for facilitating the electronic purchase of any product or a service. Specifically, the method provides a geolocated store for the electronic purchase of products and services that uses a merchant specified geofence to define the electronic offers that are promoted, performed, or otherwise presented to a viewer during an event, and in one embodiment at or near the moment the product or service is promoted, performed, or otherwise presented to the viewer.

2. Related Prior Art

A variety of systems and platforms are available to consumers that facilitate the “on-demand” purchase of goods. Two popular examples of such platforms are the cable shopping programs QVC® and the Home Shopping Network®. These programs offer their at-home viewers “deals” on preprogrammed, predetermined items. Viewers in turn are motivated to purchase the items by a spokesperson who highlights the item's benefits, the financial savings of the offer and the “limited” quantity of items available for purchase. A countdown clock is also typically used to inform the viewer when the deal will expire. These cable programs in many cases are live events. However, the use of a preprogrammed and predetermined selection of items does not allow this format of viewer purchasing to be extended over to other—more spontaneous—types of live events (e.g., concerts and/or seminars, sporting events, stage productions, shopping channels, television commercials, movie theatres) and demonstration venues (e.g., state fairs, retail stores, flea markets, etc.).

Another platform that provides for the “on-demand” purchase of goods at live events is described by U.S. Patent Publication No. 2010/0306064 to Inselburg. This reference discusses at FIGS. 5A-D and paragraph [0050] a system in which electronic billboards flash offers to attendees at a live event. For example, at FIG. 5C attendees are informed that they can receive a purchase discount from a sporting goods store if they transmit a text message to a particular number. Likewise, at FIG. 5D an electronic billboard is used to inform attendees that they have an opportunity to purchase a unique item (e.g., the homerun bat) related to the event by transmitting a text to the right number. However, even Inselburg's more advanced purchase facilitation platform suffers from the fact there is no direct link between the viewer and a payment and delivery system for the products and services promoted at the event. Stated differently, because, the electronic billboards are a passive system of communication that could be easily missed if the viewer is not looking the right way at the right time. It would, therefore, be advantageous to have a system that allows for a direct connection between the viewer and the event.

Nationally known concert ticket provider Live Nation® offers a smart phone application that allows the user to purchase songs from a selection of archived playlists of previously performed concerts. The Live Nation® app thus permits attendees to a concert—and others—an opportunity at some later time to purchase recordings of songs that were performed at a live concert. Still absent, however, is any ability for the viewers of the concert to make such purchases (and be prompted to do so) while the concert is taking place. It would therefore be desirable to provide a system that provides dynamic offers to the user that are tailored to a specific event.

In addition, none of the above mentioned systems or platforms allow for offers or storefronts on mobile devices to be specifically tailored to a particular region or geolocation. In the case of a national retailer, the products or services that are relevant to consumers in one area may not be as relevant to consumers in another area. For example, the retailer may want to promote warmer clothing in colder climates while promoting different clothing in warmer climates.

### SUMMARY OF THE INVENTION

A method is disclosed for the delivery of all kinds of offers (e.g., for goods, services, charity, etc.) to consumers at a specific geolocation or event. In one embodiment, the method includes a server operable to receive and transmit electronic data, the server including a processor module and an electronic database. The server receives a signal indicative of a location of a remote device and processes the signal to determine if the remote device is within an area of a predetermined geofence. The server transmits an offer associated with the predetermined geofence, receives a signal indicative of an acceptance to the offer from the remote device, and transmits a signal indicative of an accepted offer to a predetermined payment system.

In an additional embodiment, the method transmits a dynamic in-the-moment offer to the remote device. The dynamic in-the-moment offers are automatically sent to the remote device according to a predetermined triggering event. For example, in the case of a concert, an offer for the song currently being played by the performing band is sent to the remote device by the server after the server is triggered from a remote device by a person at the concert. The server may also trigger the dynamic in-the-moment offer by receiving a signal indicative of a trigger from the merchant or offeror. When the server receives a signal indicative of an acceptance to the dynamic in-the-moment offer from the remote device, the server transmits a signal indicative of an accepted dynamic in-the-moment offer to a predetermined payment system.

In another embodiment, the server requests permission from the remote device before transmitting offers. In embodiment, the server transmits a request to the remote device and transmits offers to the remote device after receiving a signal indicative of an acceptance to the request.

The server stores the electronic data relating to the location of the geofence along with the offers associated with a specific geofence. The remote devices in communication with the server include a mobile phone, a tablet computer, a notebook computer, a portable media player, and wearable optical devices (Google Glass).

The method for communication between the server and the remote device may include an application, a web server, and a data source (e.g., a database, XML tagged data in webpages, etc.). The application may be programmed based on a variety of known programming languages (e.g., C++, Java or Javasript, including but not limited to Sencha Touch, a web based JavaScript platform). It may be made freely available and functional on variety of mobile phone, tablet, computer, portable media player, and wearable optical device platforms including Android, iPhone, BlackBerry, Windows, and Mac. In operation, the smart application may communicate with the server to connect the application to the event (through the server) and thereafter function to receive offers and other information related to the event.

### BRIEF DESCRIPTION OF THE DRAWING

Reference will be made herein to the attached drawings wherein like figures refer to like parts throughout and wherein:

FIG. 1 is a diagrammatic view of one embodiment of the method for facilitating the purchase of goods or services of the present invention;

FIG. 2 is a flow chart depicting the process of setting up a geolocated virtual store;

FIG. 3 is a flow chart depicting the operation of the method;

FIGS. 4-8 depict the operation of the method described in FIG. 3;

FIG. 9 is a flow chart depicting the operation of the method with respect to in the moment offers; and

FIG. 10 is a flow chart depicting the transmission of payment to a predetermined payment system depicted in FIG. 8.

### DETAILED DESCRIPTION OF THE INVENTION

A method is disclosed for facilitating the electronic purchase of goods and/or services at a specific geolocation or event. In one embodiment, the method includes a server operable to receive and transmit electronic data, the server including a processor module and an electronic database. The server receives a signal indicative of a location of a remote device and processes the signal to determine if the remote device is within an area of a predetermined geofence. The server transmits an offer associated with the predetermined geofence, receives a signal indicative of an acceptance to the offer from the remote device, and transmits a signal indicative of an accepted offer to a predetermined payment system.

Alternatively, the remote device may also transmit a signal indicative of an accepted offer to a predetermined payment system. In this situation, the remote device may also transmit a signal to the server to indicate that the remote device accepted the offer.

The method may further transmit dynamic in-the-moment offers to the remote device. The dynamic in-the-moment offers may be automatically triggered by the server, an action of the merchant or offeror, or by the occurrence of a predetermined event.

A geolocation is the identification of the real world location of an object. Many modern remote devices such as mobile phone, tablets, notebook computers, portable media players, and wearable optical devices have geolocating or positioning capability. Geolocation can be performed on remote devices connected to the Internet using IP address, MAC addresses, triangulating cell towers, or Wi-Fi positioning. If the remote device has GPS capability, the GPS coordinates can be used to accurately locate the remote device.

A geofence is a virtual perimeter for a real world geographic area. Geolocation techniques may be used to establish geofences of varying size and shape which are electronically stored in a database. For example, a geofence may be established around a mall or convention center. The geofence can be supplemented using GPS coordinates or additional known positioning techniques common to remote devices. In another example, a geofence may be established by connecting to a specified Wi-Fi network centered about a location. In this situation, the geofence is the area within range of the Wi-Fi hotspot. The bounds and properties of the geofences are easily configured and stored on the server in formats like the GeoJSON geographic data structure encoding format.

An offer promotes and facilitates the electronic purchase of goods and services. The offer is an intermediary between the third party offeror and the user of the remote device. The offers are electronically stored on the server and are transmitted to the remote device. Once the offer is transmitted to the remote device, the server receives a signal indicative of the acceptance of the offer and transmits information relating to the acceptance of the offer to a predetermined payment system.

The offer transmitted by the server to the remote device may include details of a product or service, ordering and payment information, or related products or services. The offer may also redirect the user of the remote device to a product or service website, homepage, or the like. The merchant or offeror may also design the presentation of the offer to group products or services within categories. For example, a musician may design an offer to promote a specific song and then group additional songs by album within the offer. As another example, an author could group according to books, where each category has an audiobook, a digital format version, and a paperback version.

The method may include a remote device and a server having a processor module and an electronic database. At least one event account may be stored in the electronic database and configured by an event host to include a selection of offers of goods and/or services. The event account also includes a geolocation or geofence associated with the event. The server receives a signal indicative of a location of a remote device and processes the signal to determine if the remote device is within an area of a predetermined geofence. The server transmits an offer associated with the predetermined geofence, receives a signal indicative of an acceptance to the offer from the remote device, and transmits a signal indicative of an accepted offer to a predetermined payment system.

A virtual store may also be associated with or within the geofence. The virtual store can vary within the geofence according to the timestamp to change the offers available. For example, virtual store for an arena may display merchandise for a sports team on game days and then change to displaying a band's merchandise the next night when they perform. In this way, the virtual store can be easily changed to accommodate the needs of the venue without moving physical inventory. Rather, the method allows event hosts to tie the virtual store in the database to specific products during specific time periods. One skilled in the art will appreciate that the timing aspects involving the virtual stores may be altered or multiple stores may be displayed at the same time also using the method.

In one embodiment of the method, a remote device user (having previously 1) established an account with a predetermined payment system (e.g., ITunes® or Amazon.com®), a digital wallet or the like, and 2) downloaded the application to the user's remote device) uses the application to remotely connect to the account for the event on the server. Then, during the live event, the event host may have transmitted by the server to the application / remote device of the user one or more of the offers associated with the event account.

Moreover, in a particularly preferred embodiment, a dynamic in-the-moment offer will be transmitted by the server at the moment in time that is most relevant to the offer. For example, if the offer is to purchase a song, the most relevant time to transmit the offer is the moment the song is being performed by the artist or soon thereafter. The user may decline and/or ignore each dynamic in-the-moment offer transmitted by the server to the application / remote device, save the offer, or the user may opt to accept the offer. If the user chooses to accept the offer, the server may receive an acceptance signal and then facilitate a connection with the user's electronic retail account and allow the user to rapidly purchase the offered good or service.

The remote device may also transmit a signal indicative of an accepted offer to a predetermined payment system. In this situation, the remote device may also transmit a signal to the server to indicate that the remote device accepted the offer.

The server may also transmit an initial request to the remote device to transmit offers in which case the server will not transmit offers until the server receives a signal indicative of an acceptance from the remote device. Additionally, the server may transmit an in-the-moment offer request to the remote device to open a communication channel with the remote device and transmit in-the-moment offers to the remote device. One skilled in the art will appreciate that the initial offer request and the in-the-moment offer request may be combined into a single request, removed entirely, or restructured depending on the arrangement of the event schedule.

Accordingly, it will be appreciated that the disclosed method facilitates the purchase of the offered good or service at a time when the user is “in the moment” (e.g., a time during or soon after the good or service is promoted, performed, or otherwise presented to the user during the event). In addition, use of the disclosed method would mean that event organizers would not be required to transport (as much) stock to an event, would out not run out of stock and would need few (if any) on-site sales personnel. Likewise, an event attendee using the method may avoid long lines, would not need to interrupt their event experience to make a purchase, and would not need to physically carry their purchase home.

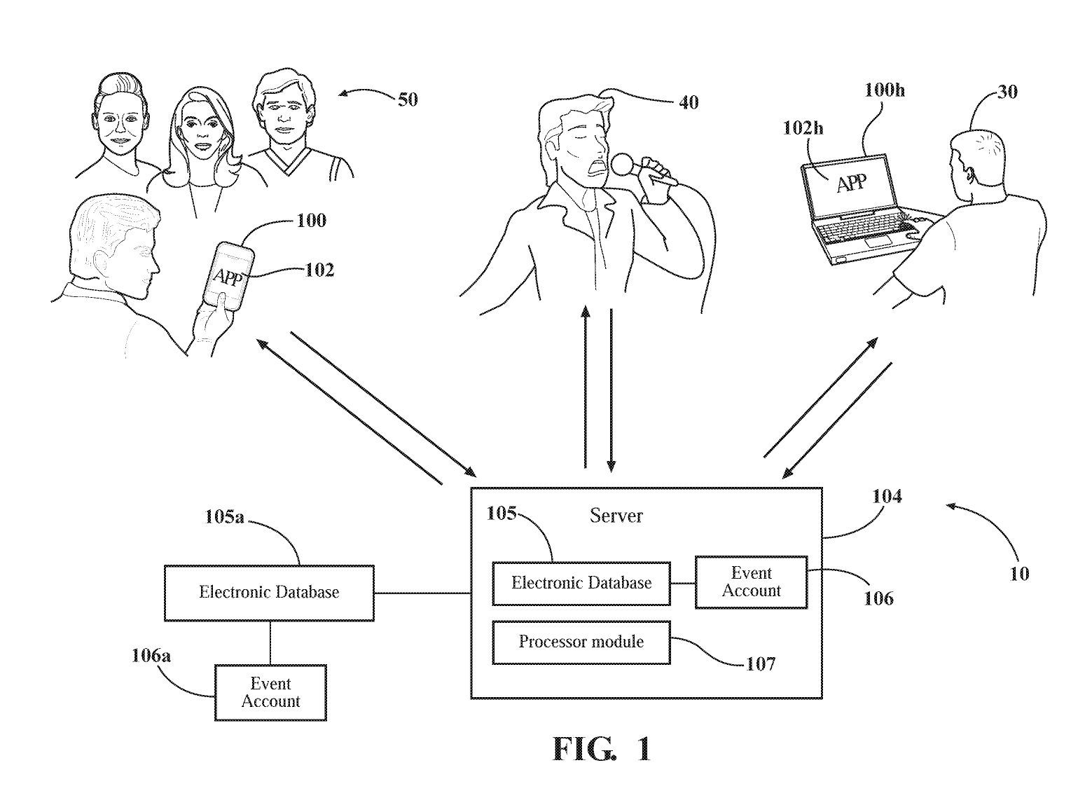

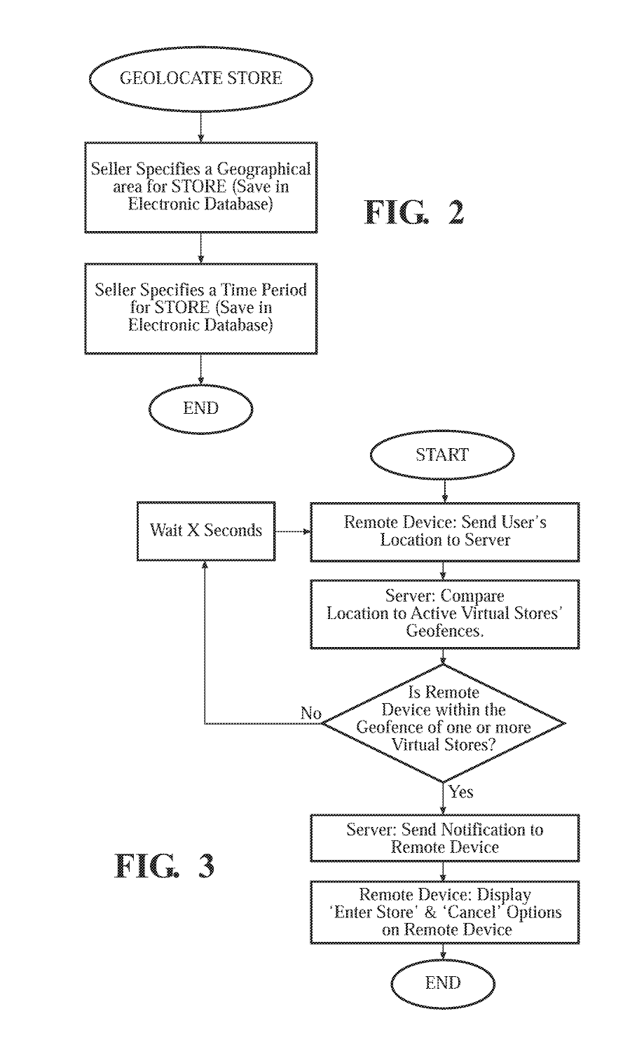

Referring now to FIG. 1, as mentioned supra, the method 10 may include the use of a remote device 100 (or the like) having an application 102 and a server 104 having a processor module 107 and an electronic database 105 associated with the server 104 having at least one event account 108. The server 104 may be a web server having one or more processors, memory, and being functional to transmit, receive, and process data and commands from (or to) one or more remote locations and devices 100 (i.e., a smart phone). The server 104 may further comprise a plurality of servers networked together as is known in the art. The servers may include Apache webserver, using a mySQL database, running on the Linux operation system, or other available programming/webserver/database/OS configurations and/or languages.

The electronic database 105 may be a rational data source or the like that is resident on the data storage media (not shown) of the server 104. Additionally, or alternatively, an alternative electronic database 105a and event account 106a may be located on a secondary server (not shown) that is remote from the server 104. It will also be appreciated that the electronic database 105 may include a plurality of electronic databases that are networked, that may function to transmit and receive data, and that may be otherwise remotely accessible as is known in the art.

Still referring to FIG. 1, the remote device 100 may include any commercially available remote devices 100 such as mobile phones, tablets, notebook computers, portable media devices, and wearable optical devices using one of several operating systems (OS). The OS may, for example, include systems available through Apple® (i056), Google® (e.g., Android) and Microsoft. The application 102 may be programmed using a variety of machine languages (e.g., a web-based programming language or platform like the Sencha Touch Javascript platform) and may be downloadable by the user to his or her remote device 100 using commercially available application services. The application can also be programmed to run directly within the mobile OS when programmed in a language specified by the OS manufacturer. To run on iOS an application is written in Objective-C, and for Android the language is written in Java. The application 102 may, for example, be downloaded from the iTunes App Store® or similar application vending services provided by Google or Microsoft.

Still referring to FIG. 1, the application 102 may include separate interfaces (not shown) depending on the permissions to be granted to a particular user/viewer. For example, a user who is an event host 30 may need permissions and an interface that allows that user to setup an event account on the server 104 and electronic database 105 , and that may also transmit commands, triggers, or have the server 104/electronic database 105 issue product or service offer information to user remote devices 100. Conversely, a user of the application may require the ability to check, or log, into the event account on the electronic database 105 so that the user may then receive the offers at the appropriate time. The interface of the application 102 for the user may also permit the remote device 100 to link to the user's electronic retail store account (such as iTunes or the like) to facilitate the

In an initial set up, an event host 30 using his or her remote device 100h, including the application 102 (or 102h), remotely communicates with the server 104 and electronic database 105 to establish an event account 106. Then, the event host 30 may upload one or more potential product or service offers that 1) are related to the event and 2) may be offered to event viewers during the event. Each listing may include, for example, product identifiers (e.g., a host's product number), a description of the product or service, pricing information, delivery information, and/or applicable legal information with disclaimers. The event host 30 may also arrange the offers according to specific categories or groups. Where a product identifier is used, it will be appreciated that the identifier may optionally not be displayed to the user but that the identifier may otherwise embedded in the listing and so passed along to the electronic vendor to assist with order processing.

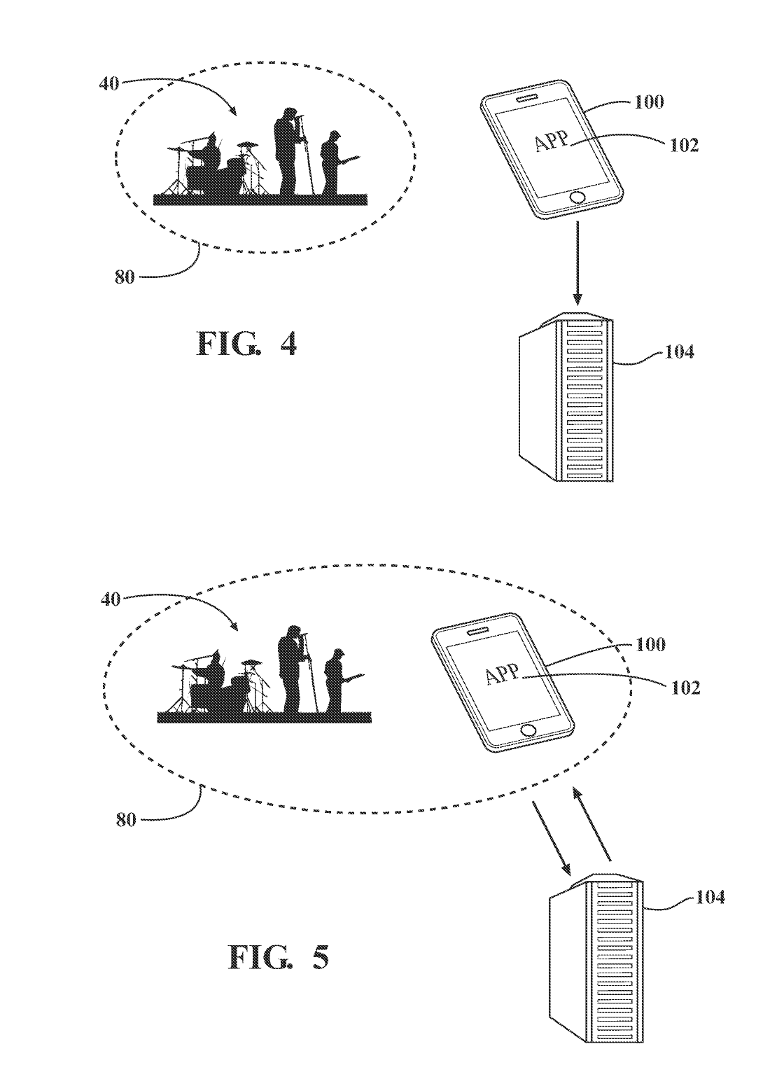

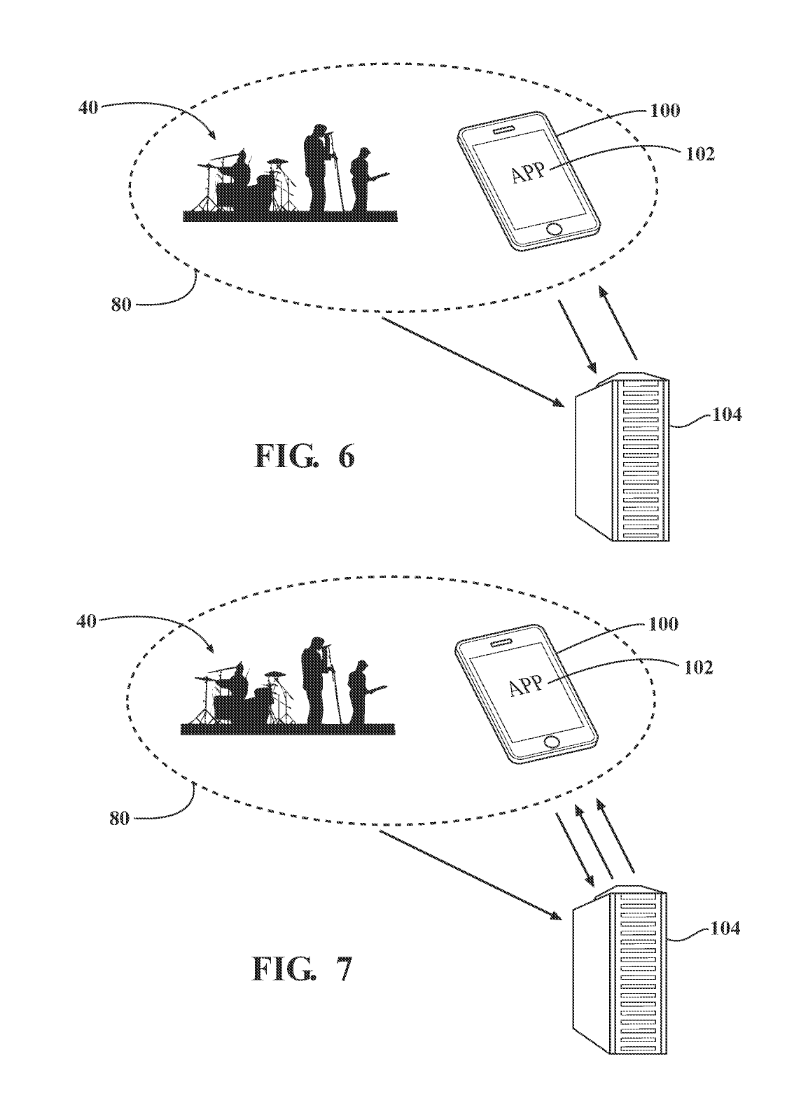

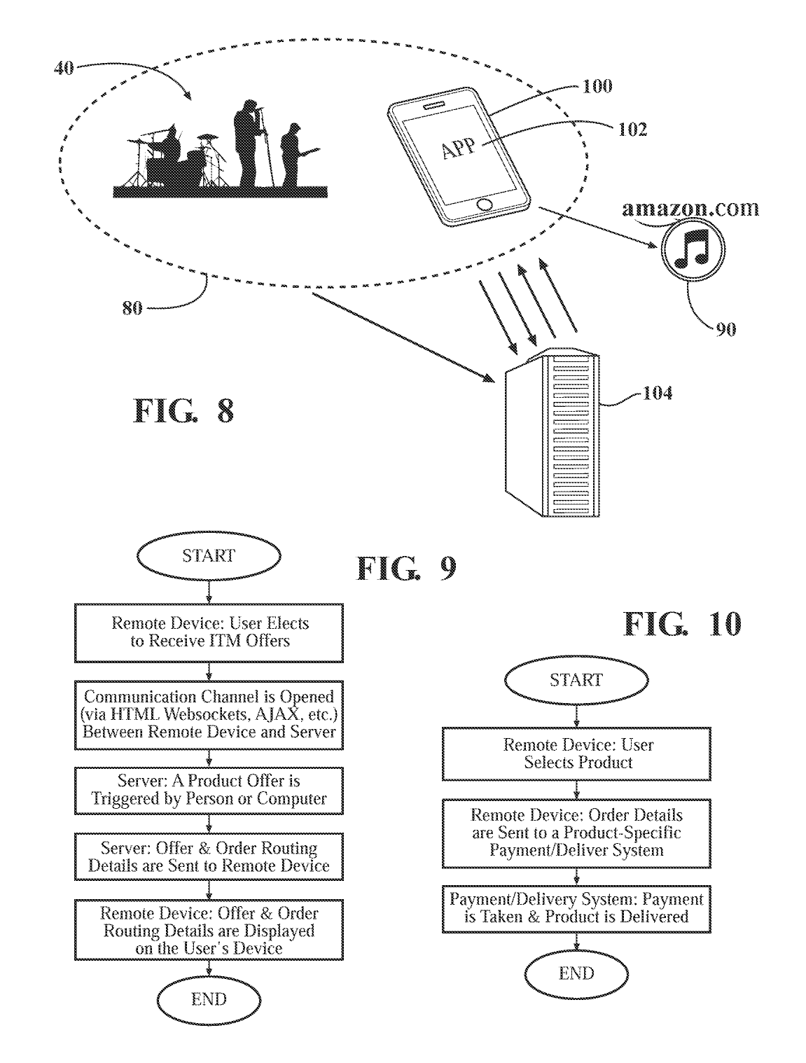

With reference now to FIGS. 3-10, the operation of the method 10 will be described. As depicted in the Figures, the server 104 receives a signal indicative of the location of the remote device 100. The server 104 processes the signal to determine if the remote device 100 is within the area of the predetermined geofence 80. When the remote device 100 is within the area of the geofence 80, the server 104 transmits an offer associated with the geofence 80. The server 104 then receives a signal indicative of an acceptance of the offer and transmits a signal indicative of the accepted offer to the predetermined payment system 90.

In another embodiment, the server 104 requests permission from the remote device 100 to transmit offers. In another embodiment, the remote device 100 transmits a signal indicative of the accepted offer to the predetermined payment system 90 and the server 104.

In another preferred embodiment, the server 104 requests permission from the remote device 100 to transmit dynamic in the moment offers. The dynamic in the moment offers may be triggered by the server 104, the host 30, the event participant 40, another third party, or by a predetermined event. When the server 104 receives acceptance of the offer from the remote device 100, the server 104 transmits the acceptance to the payment system 90. In another embodiment, the remote device 100 transmits the acceptance to the server 104 and the payment system 90. One skilled in the art will appreciate that there are alternative orders of communication between the remote device 100, the server 104, and the payment system 90 that do not depart from the spirit of the method 10.

One or more users 50 at the event, who previously established a retail account with one or more electronic vendors (iTunes, Amazon.com, or the like) (as is known in the art), may use the application 102 to access the event account 106 on the server 104 and “sign-in” to the event. It will be appreciated that the event account 106 on the server 104 may be configured by the event host 30 to limit viewer sign-in's to a predetermined time period or, as discussed infra, to a predetermined geolocation or geofence 80. An event host 30 may, for example, choose to allow users to check-in to an account for a particular event on the day of the event, or only a few hours before the event.

During a live event an event participant 40 (e.g., an artist, speaker, product demonstrator, athlete, retailer, or the like) may perform or otherwise reference a particular product or service from the list of goods and services previously uploaded to the server 104 by the event host 30. At this moment, or a time at or near this moment (including before the moment) the event host 30 using the host interface on the application 102 (or alternatively a related application 102h for use specifically by hosts) may cause the server 104 to transmit from the electronic database 105 to the remote devices 100 of the checked-in users 50, the offer to purchase the good or service being referenced, sung or the like by the event participant 40. As mentioned, the event host 30 may cause the transmission of the offer from the server 104 by manual entry of a trigger. Additionally or alternatively, where it is known that a certain event (e.g., a song) may be performed or referenced at a particular time (as may be the case with a televised live event), the server 104 may be configured by the event host 30 to automatically trigger the transmission the offer to the applications/remote devices 100 of the users checked in to the event.

In addition it will be appreciated that users 50 at the event who receive an offer need not be physically present at the event to receive the offer. For example, where a live event is a television program, viewers of the event may be at home or elsewhere.

It will be further appreciated that a server 104 having appropriate signal transmission hardware (e.g., Wi-Fi transmitter/receiver)(or the like) may be physically positioned at the event venue so that only those persons physically present at the venue may check in to the event account.

Moreover, as a still further alternative, event check-in may be password restricted (or the like) so that only verified attendees of a particular event (e.g., ticket holders) may be eligible to check-in and receive offers.

As yet a further alternative, the application 102 may utilize GPS data (or the like) from the remote device 100 to limit check-in and/or receipt of promotional offers only to users who may be physically present at the venue of the live event, a predetermined geofence 80, or other designated geolocation. In addition, the GPS data may also permit the event host 30 to transmit different offers to different viewers depending on a viewer's check-in location. Accordingly, a viewer of a live event residing on the east coast of the United States may receive a different offer from a viewer of the same live event residing on the west coast.

Upon receipt by the user's remote device 100 via the application 102 of a promotion/offer transmitted by the server 104, a user may choose to actively decline the offer, ignore the offer, save, or accept the offer. Offers may, for example, be actively declined by pressing a virtual decline key (not shown) associated with the offer that is generated by the application 102. Alternatively, the offer may be automatically withdrawn by the application 102 if the user ignores the offer for a predetermined period of time (e.g., 1, 2, 5 or 10 minutes). Finally, a user 50 may accept the offer by pressing a virtual accept key (or the like) generated on the screen with the application 102.

By accepting the offer, the user 50 via their remote device 100 transmits a signal indicative of the acceptance of the offer to the server 104. The server 104 may then (as is known in the art) connect the user's account with an electronic online retail store 90. Acceptance of an offer may, for example, cause the application 102 to open an Internet browser (not shown) on the remote device 100 that in turn opens to a web page on the retail store 90 associated with the offer. And, as a still further example, where the live event is a speaking seminar, the acceptance of an offer to purchase a book referenced by the speaker may result in the application 102 opening a browser in the remote device 100 to connect the user to the Amazon.com order page for the book. Additionally, or alternatively, the application 102 may be configured to open one or more other applications (not shown) resident on the remote device 100 and associated with the user's online retail account to thereby allow the user 50 to quickly purchase the good or service associated with the offer.

After ordering of the product or service, delivery may be effectuated using the normal channels of delivery provided by the electronic retail store. For example, depending on the nature of the product (or service) the purchase may be electronic downloaded to the remote device 100, or shipped to an address pre-stored with the online account, on the application 102, or the like.

The geofence 80 may be established by the event host 30 by defining an area in which the remote devices 100 must be located to receive the offer. The geofence 80 may be have a varying size or shape about a particular geolocation or be a network range about a Wi-Fi hotspot or the like. One skilled in the art will appreciate that creation of the geofence 80 can be tailored according to the given the geolocating capabilities of the remote device 100, the selected communication network (Wi-Fi or mobile data based), and the physical properties of the location and venue.

Having thus described certain embodiments of the disclosed method, various other embodiments will become apparent to those of skill in the art that do not depart from the scope of this description.

I claim:

1. A method comprising:
providing a server operable to receive and transmit electronic data, the server including a processor module and an electronic database;
receiving, by the server, a signal indicative of a location of a remote device;
processing, by the server, of the signal indicative of the location to determine if the remote device is within an area of a predetermined geofence;
transmitting, by the server, an offer associated with the predetermined geofence;
receiving, by the server, a signal indicative of an acceptance to the offer; and
transmitting, by the server, a signal indicative of an accepted offer to a predetermined payment system.

2. The method of claim 1, further providing a remote device, the remote device being selected from a group consisting of a mobile phone, a tablet computer, a notebook computer, a portable media player, and wearable optical devices.

3. The method of claim 2, wherein the remote device includes a global positioning system providing a location of the remote device in latitude and longitude and further comprising:
receiving, by the server, the signal indicative of the location of the remote device in latitude and longitude; and
processing, by the server, of the signal indicative of the location of the remote device in latitude and longitude to determine if the remote device is within the area of the predetermined geofence.

4. The method of claim 1, further comprising:
transmitting, by the server, a request to transmit the offer associated with the predetermined geofence; and
receiving, by the server, a signal indicative of an acceptance to the request.

5. The method of claim 2, further comprising:
receiving, by the server, a signal indicative of a time stamp of the remote device;
processing, by the server, of the signal indicative of the time stamp to determine if the remote device is within a time period of the predetermined geofence.

6. The method of claim 1, further comprising:
transmitting, by the server, a request for dynamic in-the-moment offers;
receiving, by the server, a signal indicative of an acceptance to the request for dynamic in-the-moment offers;
establishing, by the server, a communication channel;
transmitting, by the server, at least one dynamic in-the-moment offer;
receiving, by the server, a signal indicative of an acceptance to the dynamic in-the-moment offer; and
transmitting, by the server, a signal indicative of an accepted dynamic in-the-moment offer to a predetermined payment system.

7. The method of claim 6, further comprising:
transmitting, by the server, the at least one dynamic in-the-moment offer according to a trigger event.

8. The method of claim 7, wherein the trigger event is selected from a group consisting of a predetermined server action, a third party input, an occurrence of a predetermined audio visual event, a time period, and a geofence event.

9. The method of claim 1, wherein at least one event account is stored in the electronic database, the event account accessible on the server by an event host and having at least one offer associated with said event account.

10. The method of claim 1, wherein an application on the remote device is in communication with the server and displays the offers on the remote device.

11. A method comprising:
providing a remote device operable to receive and transmit electronic data;;
transmitting, by the remote device, a signal indicative of a location of a remote device;
receiving, by the remote device, a request for dynamic in-the-moment offers if the remote device is within an area of a predetermined geofence;
transmitting, by the remote device, a signal indicative of an acceptance to the request for dynamic in-the-moment offers;
receiving, by the remote device, a communication channel;
receiving, by the remote device, at least one dynamic in-the-moment offer;
transmitting, by the remote device, a signal indicative of an acceptance to the dynamic in-the-moment offer; and
transmitting, by the remote device, a signal indicative of an accepted dynamic in-the-moment offer to a predetermined payment system.

12. The method of claim 11, further comprising the remote device being selected from a group consisting of a mobile phone, a tablet computer, a notebook computer, a portable media player, and wearable optical devices.

13. The method of claim 12, wherein the remote device includes a global positioning system providing a location of the remote device in latitude and longitude and further comprising:
transmitting, by the remote device, the signal indicative of the location of the remote device in latitude and longitude.

14. The method of claim 11, further comprising:
receiving, by the remote device, a request to transmit the offer associated with the predetermined geofence; and
transmitting, by the remote device, a signal indicative of an acceptance to the request.

15. The method of claim 11, further comprising:
transmitting, by the remote device, a signal indicative of a time stamp of the remote device;
receiving, by the remote device, a request for dynamic in-the-moment offers if the remote device is within a time period of the predetermined geofence.

16. The method of claim 11, further comprising:
receiving, by the remote device, the at least one dynamic in-the-moment offer according to a trigger event.

17. The method of claim 16, wherein the trigger event is selected from a group consisting of a predetermined server action, a third party input, an occurrence of a predetermined audio visual event, a time period, and a geofence event.

18. The method of claim 11, wherein an application on the remote device is in communication with a server and displays the offers on the remote device.

19. A method comprising:
providing a server operable to receive and transmit electronic data, the server including a processor module and an electronic database;
providing a remote device operable to receive and transmit electronic data, the remote device including a processor module and an application in communication with the server;
receiving, by the server, a signal indicative of a location of a remote device;
processing, by the server, of the signal indicative of the location to determine if the remote device is within an area of a predetermined geofence;
transmitting, by the server, an offer associated with the predetermined geofence;
receiving, by the server, a signal indicative of an acceptance to the offer; and
transmitting, by the remote device, a signal indicative of an accepted offer to a predetermined payment system.

20. The method of claim 19, further comprising:
transmitting, by the server, a request for dynamic in-the-moment offers;
receiving, by the server, a signal indicative of an acceptance to the request for dynamic in-the-moment offers;
establishing, by the server, a communication channel;
transmitting, by the server, at least one dynamic in-the-moment offer;
receiving, by the server, a signal indicative of an acceptance to the dynamic in-the-moment offer; and
transmitting, by the remote device, a signal indicative of an accepted dynamic in-the-moment offer to a predetermined payment system.
